(19) United States
(12) Patent Application Publication
(10) Pub. No.: US 2026/0228980 A1
(43) Pub. Date: Aug. 6, 2026

(54) VIRTUAL SPACE-PROVIDING APPARATUS, VIRTUAL SPACE-PROVIDING METHOD, AND NON-TRANSITORY COMPUTER-READABLE MEDIUM

(71) Applicant: NEC Corporation, Tokyo (JP)

(72) Inventor: Toshinori HASHIMOTO, Tokyo (JP)

(73) Assignee: NEC Corporation, Tokyo (JP)

(21) Appl. No.: 19/145,983

(22) PCT Filed: Mar. 16, 2023
(86) PCT No.: PCT/JP2023/010339

§ 371 Date: Jul. 7, 2025

(51) Int. Cl. G06T 19/00

(52) U.S. Cl. CPC G06T 19/00

(57) ABSTRACT

A virtual space-providing apparatus obtains reference three-dimensional data, which is three-dimensional data which expresses a target location at a reference time. The virtual space-providing apparatus determines a replacement time, which is a time which differs from the reference time, and a replacement region, which is a region constituting the target location where an object included therein should undergo replacement by replacing the object at the reference time with the object at the replacement time. The virtual space-providing apparatus obtains replacement three-dimensional data, which is three-dimensional data that expresses the replacement region at the replacement time. The virtual space-providing apparatus generates virtual space data, which is three-dimensional data which expresses the virtual space, by combining the reference three-dimensional data and the replacement three-dimensional data with one another.

### TECHNICAL FIELD

The present disclosure relates to a virtual space-providing apparatus, a virtual space-providing method, and a non-transitory computer-readable medium.

### BACKGROUND ART

A system has been developed that provides an image of a three-dimensional space to a user, by using three-dimensional data of a building that really exists or the like. For example, PTL 1 discloses a system that provides an augmented reality video obtained by synthesizing a building that has existed in the past on a real space, to a user who sees a specific place in the real space using an observation mirror.

### CITATION LIST

### Patent Literature

PTL 1: JP 2018-128815 A

### SUMMARY OF INVENTION

### Technical Problem

In PTL 1, a past building or the like to be synthesized with a specific place in a real space is determined in advance. The present disclosure has been made in view of this problem, and one of objects of the present disclosure is to provide a new technology for providing a virtual space.

### Solution to Problem

A virtual space-providing apparatus according to the present disclosure includes first acquisition means for acquiring reference three-dimensional data that is three-dimensional data that expresses a target location at a reference time, determination means for determining a replacement time that is a time point different from the reference time and a replacement region that is a region, in the target location, where an object included therein is to be replaced from an object at the reference time with an object at the replacement time, second acquisition means for acquiring replacement three-dimensional data that is three-dimensional data that expresses the replacement region at the replacement time, and generation means for generating virtual space data that is three-dimensional data that expresses a virtual space, by combining the reference three-dimensional data and the replacement three-dimensional data.

A virtual space-providing method according to the present disclosure is executed by a computer. The method includes a first acquisition step for acquiring reference three-dimensional data that is three-dimensional data that expresses a target location at a reference time, a determination step for determining a replacement time that is a time point different from the reference time and a replacement region that is a region, in the target location, where an object included therein is to be replaced from an object at the reference time with an object at the replacement time, a second acquisition step for acquiring replacement three-dimensional data that is three-dimensional data that expresses the replacement region at the replacement time, and a generation step for generating virtual space data that is three-dimensional data that expresses a virtual space, by combining the reference three-dimensional data and the replacement three-dimensional data.

A non-transitory computer readable medium according to the present disclosure stores a program that causes a computer to execute a disclosed virtual space-providing method.

### ADVANTAGEOUS EFFECTS OF INVENTION

According to the present disclosure, a new technology for detecting a virtual space is provided.

### BRIEF DESCRIPTION OF DRAWINGS

FIG. 1 is a diagram illustrating an overview of an operation of a virtual space-providing apparatus according to a first example embodiment.

FIG. 2 is a block diagram illustrating a functional configuration of the virtual space-providing apparatus according to the first example embodiment.

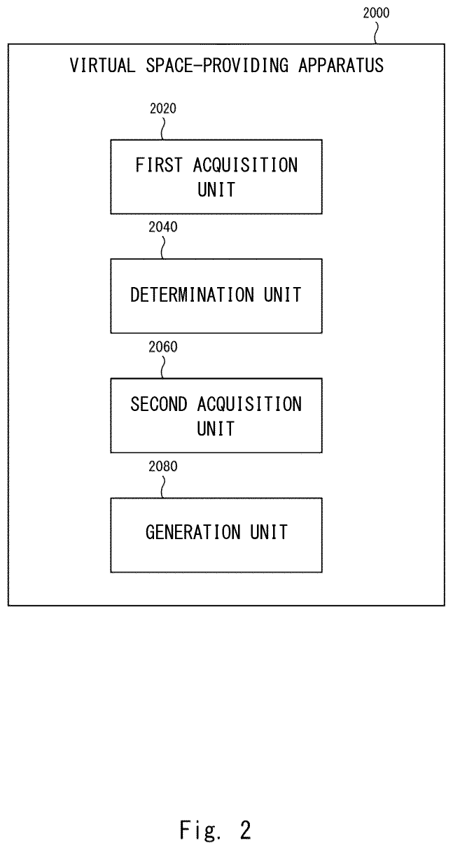

FIG. 3 is a block diagram illustrating a hardware configuration of a computer that implements the virtual space-providing apparatus according to the first example embodiment.

FIG. 4 is a flowchart illustrating a flow of processing executed by the virtual space-providing apparatus according to the first example embodiment.

FIG. 5 is a diagram illustrating a use environment of the virtual space-providing apparatus.

FIG. 6 is a diagram illustrating a configuration of schedule information.

FIG. 7 is a diagram illustrating a state where a replacement time and a replacement region are designated by a user.

FIG. 8 is a first diagram illustrating a case where the replacement region and the replacement time are determined by an utterance of an avatar.

FIG. 9 is a second diagram illustrating a case where the replacement region and the replacement time are determined by the utterance of the avatar.

FIG. 10 is a diagram illustrating a case where the replacement time and the replacement region are determined based on an attribute of the avatar.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description. In addition, unless otherwise described, predetermined values such as predetermined values and threshold values are stored in advance in a storage device or the like accessible from a device using the values. Furthermore, unless otherwise described, the storage unit includes one or more storage devices of any number.

### First Example Embodiment

### Overview

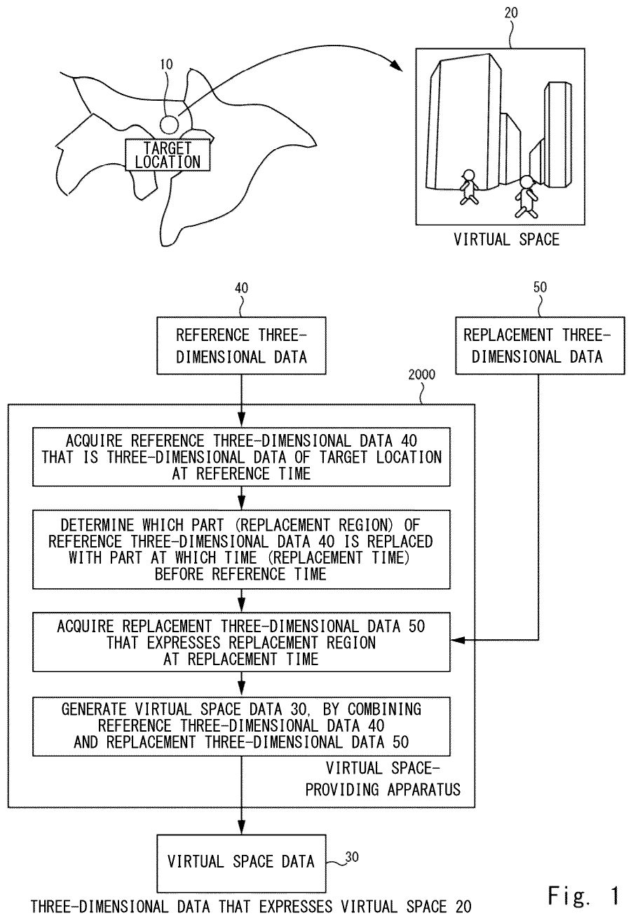

FIG. 1 is a diagram illustrating an overview of an operation of a virtual space-providing apparatus 2000 according to a first example embodiment. Here, FIG. 1 is a diagram for facilitating understanding of the overview of the virtual space-providing apparatus 2000, and the operation of the virtual space-providing apparatus 2000 is not limited to that illustrated in FIG. 1.

The virtual space-providing apparatus 2000 generates virtual space data 30 that is three-dimensional data that expresses a virtual three-dimensional space. A virtual space expressed by the virtual space data 30 is referred to as a virtual space 20. Here, the virtual three-dimensional space can be also expressed as a metaverse or the like. The three-dimensional data includes, for example, polygon data that expresses a shape of each object or the like and texture information that expresses a texture of each object.

The virtual space 20 expresses a space in which a scene of a real location (hereinafter, a target location 10) at a reference time and a scene of the target location 10 at a replacement time which differs from the reference time are integrated. For example, in the virtual space 20, some objects are replaced from those at the reference time with those at the replacement time. The object to be replaced is, for example, a building, a signboard, a vehicle, a road, or the like.

It is assumed that the replacement time be a time point before the reference time. In this case, in the virtual space 20, some buildings or the like are replaced with buildings or the like that have existed in the past from the reference time. Therefore, in the virtual space 20, the scene at the reference time (for example, a current scene) and a past scene are integrated. As a result, for example, the past target location 10 can be reproduced in the virtual space 20.

On the other hand, it is assumed that the replacement time be a future time point from the reference time. In this case, in the virtual space 20, some buildings or the like are replaced with buildings or the like expected to be at the location in the future than the reference time. Therefore, in the virtual space 20, the scene at the reference time (for example, the current scene) and a future scene can be integrated. As a result, for example, a future target location 10 can be simulated in the virtual space 20. As a more specific example, in a case where a new facility is scheduled to be constructed at the target location 10, it is possible to see a state of the target location 10 after the new building is completed, in the virtual space 20.

In order to generate the virtual space data 30, the virtual space-providing apparatus 2000 executes, for example, the following processing. First, the virtual space-providing apparatus 2000 acquires reference three-dimensional data 40 that is three-dimensional data that expresses the target location 10 at the reference time. Furthermore, the virtual space-providing apparatus 2000 determines the replacement time and a replacement region. The replacement region is a region where an object included therein should undergo replacement by replacing the object at the reference time with the object at the replacement time, in the target location 10. The virtual space-providing apparatus 2000 acquires replacement three-dimensional data 50 that is three-dimensional data that expresses the replacement region at the replacement time. Then, the virtual space-providing apparatus 2000 generates the virtual space data 30 that expresses the virtual space 20, by combining the reference three-dimensional data 40 and the replacement three-dimensional data 50 with one another.

### Example of Operation and Effect

The virtual space-providing apparatus 2000 according to the present example embodiment determines the replacement time and the replacement region. The replacement time is a time point that differs from the reference time. The replacement region is a region where three-dimensional data related to the reference time should undergo replacement with three-dimensional data related to the replacement time, in the reference three-dimensional data 40 that expresses the target location 10 at the reference time. Then, the virtual space-providing apparatus 2000 generates the virtual space data 30 that expresses the virtual space 20 to be provided to a user, by combining the replacement three-dimensional data 50 that expresses the replacement region at the replacement time and the reference three-dimensional data 40 with one another.

According to the virtual space-providing apparatus 2000, a new technology for providing a virtual space such that “when a partial region of the virtual space is replaced with a region at the past or future time point, which region should be replaced with three-dimensional data at which time point is dynamically determined”.

Hereinafter, the virtual space-providing apparatus 2000 according to the present example embodiment will be described in more detail.

### Example of Functional Configuration

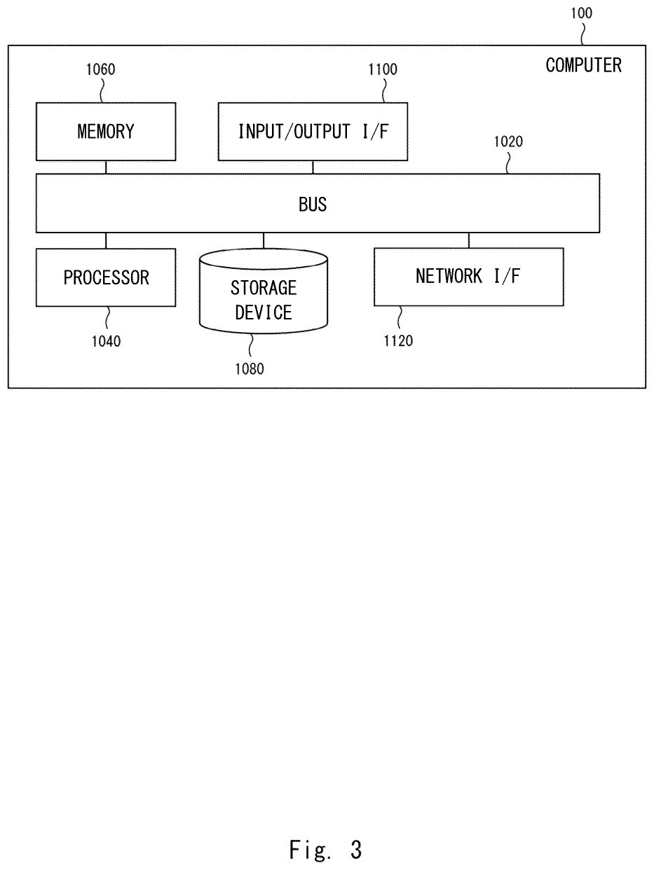

FIG. 3 is a block diagram illustrating a functional configuration of the virtual space-providing apparatus 2000 according to the first example embodiment. The virtual space-providing apparatus 2000 includes a first acquisition unit 2020, a determination unit 2040, a second acquisition unit 2060, and a generation unit 2080. The first acquisition unit 2020 acquires the reference three-dimensional data 40. The determination unit 2040 determines the replacement time and the replacement region. The second acquisition unit 2060 acquires the replacement three-dimensional data 50 that expresses the replacement region at the replacement time. The generation unit 2080 generates the virtual space data 30 using the reference three-dimensional data 40 and the replacement three-dimensional data 50.

### Example of Hardware Configuration

Each functional component of the virtual space-providing apparatus 2000 may be implemented by hardware (for example, a hard-wired electronic circuit or the like) that implements each functional component, or may be implemented by a combination of hardware and software (for example, a combination of an electronic circuit and a program that controls the electronic circuit or the like). Hereinafter, a case where each functional component of the virtual space-providing apparatus 2000 is implemented by a combination of hardware and software will be further described.

FIG. 3 is a block diagram illustrating a hardware configuration of a computer 1000 that implements the virtual space-providing apparatus 2000. The computer 1000 is any computer. For example, the computer 1000 is a stationary computer such as a personal computer (PC) or a server machine. In another example, for example, the computer 1000 is a portable computer such as a smartphone or a tablet terminal. The computer 1000 may be a special purpose computer designed to implement the virtual space-providing apparatus 2000, or may be a general-purpose computer.

For example, by installing a predetermined application in the computer 1000, each function of the virtual space-providing apparatus 2000 is implemented in the computer 1000. The above-described application is configured by a program for implementing the functional components of the virtual space-providing apparatus 2000. Note that any method of acquiring the program can be used. For example, the program can be acquired from a storage medium (a DVD disk, a USB memory, or the like) in which the program is stored. The program can also be acquired, for example, by downloading the program from a server device that manages the storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, a method of connecting the processor 1040 and the like to each other is not limited to the bus connection.

The processor 1040 is any of processors such as a central processing unit (CPU), a graphics processing unit (GPU), or a field-programmable gate array (FPGA). The memory 1060 is a primary storage device implemented by using a random access memory (RAM) or the like. The storage device 1080 is a secondary storage device implemented by using a hard disk, a solid state drive (SSD), a memory card, read only memory (ROM), or the like.

The input/output interface 1100 is an interface connecting the computer 1000 and an input/output device. For example, an input device such as a keyboard and an output device such as a display device are connected to the

The network interface 1120 is an interface connecting the computer 1000 to a network. The network may be a local area network (LAN) or a wide area network (WAN).

The storage device 1080 stores a program (a program for implementing the above-described application) for implementing each functional component of the virtual space-providing apparatus 2000. The processor 1040 loads the program onto the memory 1060 and executes the program to implement each functional component of the virtual space-providing apparatus 2000.

The virtual space-providing apparatus 2000 may be implemented by one computer 1000 or may be implemented by a plurality of computers 1000. In the latter case, the configurations of the computers 1000 do not need to be the same, and can be different from each other.

### Flow of Processing

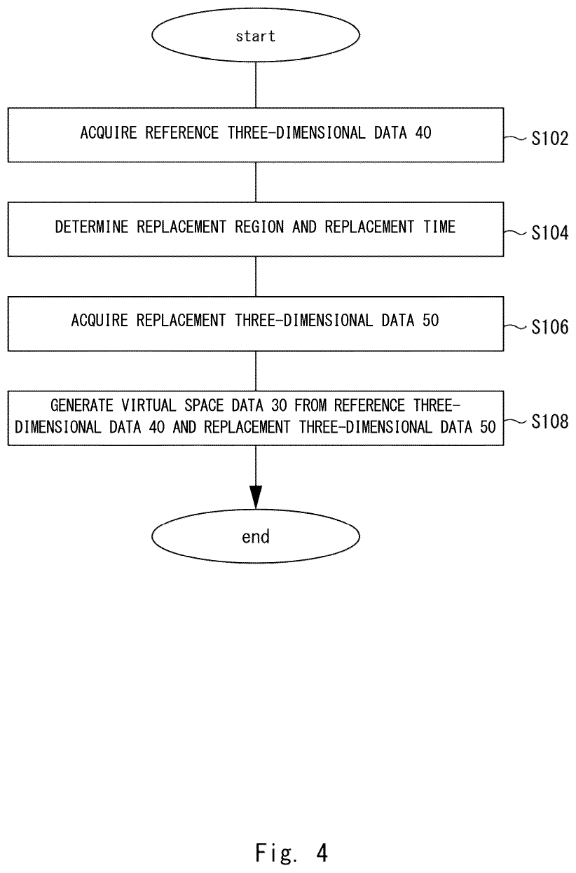

FIG. 4 is a flowchart illustrating a flow of processing executed by the virtual space-providing apparatus 2000 according to the first example embodiment. The first acquisition unit 2020 acquires the reference three-dimensional data 40 (S102). The determination unit 2040 determines the replacement time and the replacement region (S104). The second acquisition unit 2060 acquires the replacement three-dimensional data 50 (S106). The generation unit 2080 generates the virtual space data 30 using the reference three-dimensional data 40 and the replacement three-dimensional data 50 (S108).

### Usage Example of Virtual Space 20

In order to facilitate understanding of the virtual space-providing apparatus 2000, a usage example of the virtual space 20 provided by the virtual space-providing apparatus 2000 will be described. The usage example described here is an example, and the usage example of the virtual space-providing apparatus 2000 is not limited to those described below.

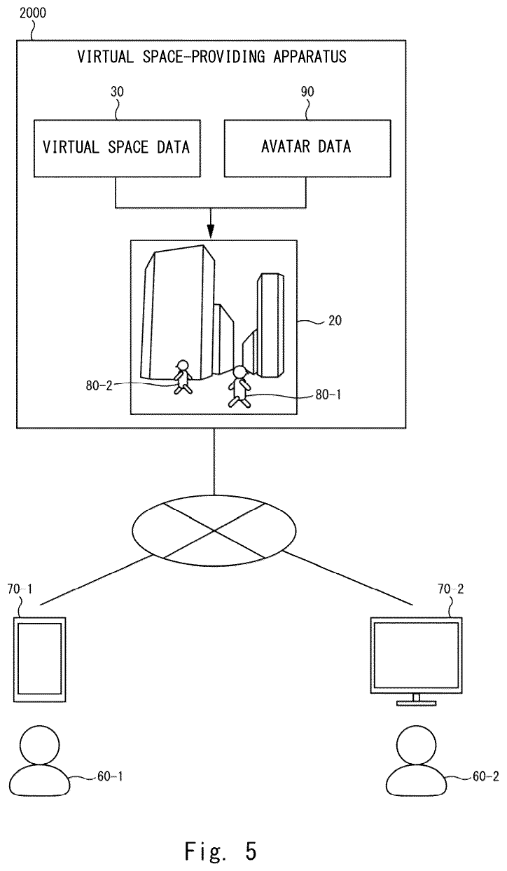

FIG. 5 is a diagram illustrating a use environment of the virtual space-providing apparatus 2000. A user 60 accesses the virtual space-providing apparatus 2000, using a user terminal 70. In FIG. 5, a user 60-1 uses a user terminal 70-1, and a user 60-2 uses a user terminal 70-2.

The virtual space 20 is a virtual space where each user 60 can participate using an avatar. In FIG. 5, avatars 80-1 and 80-2 are respectively avatars of the users 60-1 and 60-2.

The user 60 can freely move in the virtual space 20, by operating one's avatar 80. Furthermore, the user 60 can have a conversation with another user 60 via the avatar 80. Various types of existing techniques can be used for a specific technique for implementing a movement of the avatar in the virtual space or a specific technique for implementing a conversation between the avatars in the virtual space.

The virtual space-providing apparatus 2000 holds avatar data 90 that is information related to each avatar 80, in addition to the virtual space data 30 that expresses the virtual space 20. The avatar data 90 indicates identification information of the user 60 who operates the avatar 80, definition information of an appearance of the avatar 80, attribute information of the avatar 80, a position, a posture, or the like of the avatar 80 in the virtual space 20, for each avatar 80. The attribute information of the avatar 80 is, for example, an age, sex, personality, hobby, language, hometown, current address, or the like. In a case where a plurality of languages can be used, the plurality of languages may be set as the language of the avatar 80.

The attribute of the avatar 80 may match a real attribute of the user 60 who operates the avatar 80 or does not need to match the real attribute of the user 60. In the former case, for example, if the age of the user 60 is 30 years old, the age of the avatar 80 is automatically set to 30 years old. On the other hand, in the latter case, for example, even if the age of the user 60 is 30 years old, any age such as 20 years old or 40 years old can be set to the age of the avatar 80. the user terminal 70 of each user 60. The display screen provided to the user 60 includes, for example, a video obtained by imaging a predetermined range including the avatar 80 of the user 60, from a camera (hereinafter, a virtual camera) that is virtually arranged on the virtual space 20. Here, various existing techniques can be used for a specific technique for providing the video of the virtual space including the avatar, to the user of the avatar arranged in the virtual space.

For example, first, the virtual space-providing apparatus 2000 provides the virtual space 20 that expresses the target location 10 at the reference time. That is, the virtual space-providing apparatus 2000 acquires the reference three-dimensional data 40 and generates the virtual space 20 by generating the virtual space data 30 including the reference three-dimensional data 40. Therefore, the virtual space 20 provided first expresses the target location 10 at the reference time, as a whole.

For example, it is assumed that the target location 10 be a district called an A district. Furthermore, it is assumed that latest three-dimensional data prepared for the A district be three-dimensional data that expresses the A district at 1:00 pm on Feb. 27, 2023.

In this case, for example, the virtual space-providing apparatus 2000 acquires three-dimensional data generated for the A district at 1:00 pm on Feb. 27, 2023, as the reference three-dimensional data 40. Here, the reference time is 1:00 pm on Feb. 27, 2023. Then, the virtual space-providing apparatus 2000 generates the virtual space data 30 including the reference three-dimensional data 40.

The user 60 accesses the virtual space-providing apparatus 2000 using the user terminal 70 and logs in a service provided by the virtual space-providing apparatus 2000, so as to add the own avatar to the virtual space 20. In this way, the user 60 can experience a virtual space imitating the A district at 1:00 pm on Feb. 27, 2023, using the own avatar.

Thereafter, the virtual space-providing apparatus 2000 dynamically replaces a part of the virtual space 20 with the replacement three-dimensional data 50. As a result, the virtual space 20 changes from the virtual space that expresses the target location 10 at the reference time to a space where the target location 10 at the reference time and the target location 10 at a time point in the past or future from the reference time are integrated.

For example, the user 60 designates a part of the virtual space 20 (for example, a specific building or the like), on the display screen displayed on a display device of the user terminal 70. Moreover, the user 60 designates a part at which time point is to be replaced with the designated part (that is, the replacement time). As a result, in the virtual space 20, the part designated by the user 60 is replaced from the part at the reference time with the part at the designated replacement time. In this way, the user 60 can replace a part of the scene of the target location 10 with a scene at a time point in the past or future designated by the user 60, in the virtual space 20.

For example, it is assumed that a building that the user 60 has visited in the past do not already exist at a current time point. In such a case, the user 60 designates a place where the building has existed in the past, as the replacement region and designates a time point when the user 60 has visited the building in the past, as the replacement time. In this way, the user 60 can see the place where the user 60 has visited in the past and feel nostalgia for the past, in the virtual space 20.

In addition, for example, the virtual space-providing apparatus 2000 dynamically replaces a part of the virtual space 20, in accordance with an utterance of the avatar. For example, it is assumed that the avatar have uttered that “there was a movie theater around here in the past”. In this case, the virtual space-providing apparatus 2000 acquires three-dimensional data of this movie theater as the replacement three-dimensional data 50 and replaces a part of the virtual space data 30 with the replacement three-dimensional data 50. As a result, the movie theater that has existed in the past, represented by the utterance of the avatar is reproduced in the virtual space 20.

By replacing a part of the virtual space 20 with a building in the past or future or the like in accordance with the utterance of the avatar in this way, a part of the virtual space 20 can be appropriately replaced with one in the past or future, in accordance with the utterance of the avatar. In this way, for example, in a case where avatars gather and have a conversation, the scene of the virtual space 20 can be appropriately changed to one in the past or future, in accordance with a topic of the conversation. Therefore, the user 60 can easily and naturally experience the target location 10 in the past or future.

The method of dynamically replacing a part of the virtual space 20 is not limited to the method described above. More specific description on each method described above will be described later.

Hereinafter, each operation of the virtual space-providing apparatus 2000 will be described in more detail.

### Acquisition of Reference Three-Dimensional Data 40: S102

The first acquisition unit 2020 acquires the reference three-dimensional data 40 (S102). As described above, the reference three-dimensional data 40 is three-dimensional data that expresses the target location 10 at the reference time. Here, the reference time and the target location 10 may be determined in advance or can be designated. In the former case, the first acquisition unit 2020 acquires the reference three-dimensional data 40 determined in advance.

In a case where the target location 10 can be designated, the first acquisition unit 2020 accepts designation of the target location 10. For example, the virtual space-providing apparatus 2000 provides an input interface (for example, an input screen) used to designate the target location 10, to the user of the virtual space-providing apparatus 2000. The virtual space-providing apparatus 2000 determines a place designated by using the input interface, as the target location 10.

For example, the input interface is an input screen that can designate a part of a map. The user of the virtual space-providing apparatus 2000 performs an input for designating a range to be treated as the target location 10 (in other words, to be expressed as the virtual space 20), for a map displayed on the input screen. The first acquisition unit 2020 determines a place related to a region designated by the user, as the target location 10.

The method of designating the target location 10 is not limited to the method using a map. For example, the target location 10 may be designated by an address. For example, by designating an address “Shibuya city, Tokyo”, an entire area of Shibuya city, Tokyo can be designated as the target location 10.

The target location 10 may be selected from among predetermined options. In this case, for example, the first acquisition unit 2020 provides an input screen indicating options of the target location 10, to the user. The user selects a place to be treated as the target location 10, from among the options indicated in the input screen.

In a case where the target location 10 can be designated, for all places that may be designated as the target location 10, three-dimensional data at the reference time is stored in advance in a storage unit that is accessible from the virtual space-providing apparatus 2000. For example, it is assumed that any place in Japan can be designated as the target location 10. In this case, three-dimensional data at the reference time is prepared for the entire Japan. The first acquisition unit 2020 acquires three-dimensional data of a range designated by the user as the target location 10, as the reference three-dimensional data 40, from the three-dimensional data of Japan at the reference time.

In a case where the reference time can be designated, the first acquisition unit 2020 provides an input interface (for example, an input screen) used to designate the reference time, to the user of the virtual space-providing apparatus 2000. The virtual space-providing apparatus 2000 determines a time point designated by using the input interface, as the reference time. The input interface used to designate the reference time is a screen including an interface that can designate a time point, for example, a text box, a drumroll type interface, a calendar, or the like.

In a case where the reference time can be designated, for each of a plurality of time points, the three-dimensional data of the target location 10 is stored in advance in the storage unit that is accessible from the virtual space-providing apparatus 2000. For example, the determination unit 2040 acquires three-dimensional data related to a time point closest to the reference time, as the reference three-dimensional data 40, among the plurality of pieces of three-dimensional data prepared for the target location 10.

Here, as illustrated in FIG. 5, the virtual space 20 may be shared by a plurality of users. Therefore, for example, the first acquisition unit 2020 accepts the designation of the target location 10 and the reference time, from each of the plurality of users. In this case, for example, the virtual space-providing apparatus 2000 generates a group of users having the same pair of the target location 10 and the reference time. Then, the virtual space-providing apparatus 2000 generates the virtual space 20 for each group.

In addition, for example, before the target location 10 and the reference time are designated, the group of the user may be generated in advance. In this case, for example, the virtual space-providing apparatus 2000 determines the target location 10 and the reference time for the group, for each group. For example, for each group, a representative user of the group designates the target location 10 and the reference time of the group.

In addition, for example, a pair of the target location 10 and the reference time may be designated by an administrator of the virtual space-providing apparatus 2000.

### Determination of Replacement Time and Replacement Region: S104

The determination unit 2040 determines the replacement time and the replacement region (S104). Here, there may be various methods of determining the replacement time and the replacement region. Hereinafter, various methods of determining the replacement time and the replacement region will be described.

### Designation by User

The determination unit 2040 accepts designation of the replacement region and the replacement time, from the user of the virtual space-providing apparatus 2000. In this case, the determination unit 2040 provides a user interface that can designate the replacement region and the replacement time, to the user terminal. The determination unit 2040 determines a region and a time designated by using the user interface, as the replacement region and the replacement time, respectively. Hereinafter, a method of designating each of the replacement region and the replacement time will be described.

For example, the replacement region can be designated by using a map of the target location 10. In this case, the determination unit 2040 provides an input screen including the map of the target location 10, to the user terminal. The user designates a partial region of the map on the input screen, as the replacement region.

In addition, for example, on a display screen (a screen on which the user can operate an avatar) displaying the virtual space 20, the user may designate a part of the virtual space 20 on the display screen as the replacement region. In this case, for example, the user designates a specific object (for example, a building, a signboard, or the like) displayed on the display screen, as the replacement region. In addition, for example, the user may designate the replacement region, by designating a region having a certain shape such as a rectangle on the display screen.

In addition, for example, the user may designate a name or a type of an object to be treated as the replacement region. Specifically, by designating a name of a facility, a type of a facility (a restaurant, a movie theater, a station, or the like), or the like, the replacement region can be designated.

In a case where the name of the facility and the type of the facility are used in this way, for example, for each object, the three-dimensional data indicates an attribute of the object, in association with shape data or the like of the object. The attribute of the object indicates a name, a type, or the like of the object.

In addition, for example, the user may designate the replacement region by an address.

The replacement time can be designated, for example, by using any user interface that can designate a time point. Examples of the user interface that can be used to designate the time point are as described above.

An input interface of the replacement time is added on the screen used to designate the replacement region, for example, in response to the designation of the replacement region. In this case, the determination unit 2040 accepts the designation of the replacement region and replacement time in this order.

The input interface of the replacement time is provided to the user at any timing, and the timing is not limited to a timing after the replacement region is designated. For example, the replacement time may be designated, before the designation of the replacement region.

In a case where the user designates the plurality of replacement regions, a single replacement time common to all the replacement regions may be designated, or the replacement time may be designated for each replacement region.

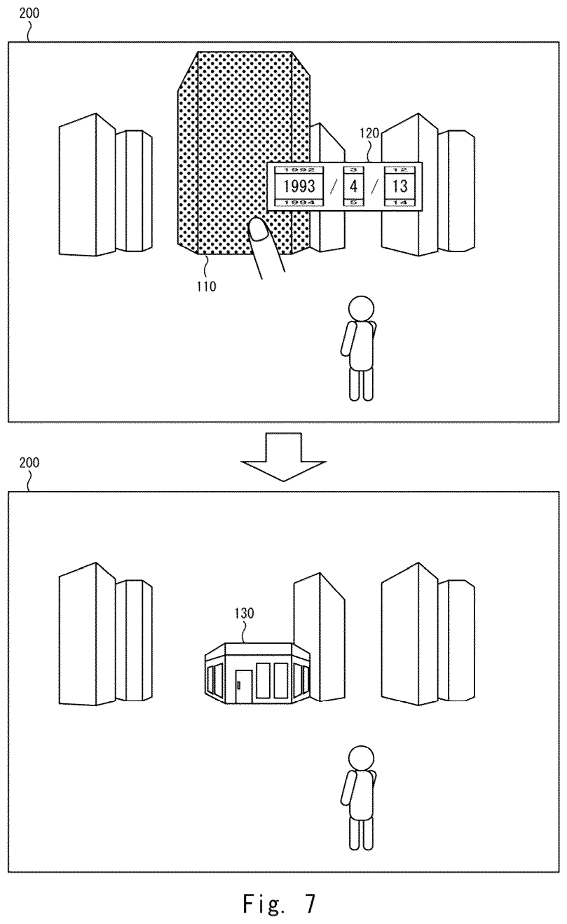

FIG. 7 is a diagram illustrating a state where the replacement time and the replacement region are designated by the user. In the example in FIG. 7, the user can designate the replacement region, by designating a building or the like on a display screen 200. Specifically, a building 110 is designated. In this example, a dot pattern is superimposed on an object designated by the user so that the object designated by the user can be easily grasped.

Moreover, the user designates the replacement time, using a drumroll type input interface 120. Specifically, “Apr. 13, 1993” is designated as the replacement time.

In response to the designation of the replacement region and the replacement time, replacement is executed. Specifically, the designated building 110 is replaced with a building 130 that was on the place on Apr. 13, 1993.

### Designation by Schedule

Execution of replacement may be scheduled in advance so that a part of the virtual space 20 is automatically replaced at a specific date and time. In this case, schedule information indicating the replacement schedule is stored in the storage unit that is accessible from the virtual space-providing apparatus 2000.

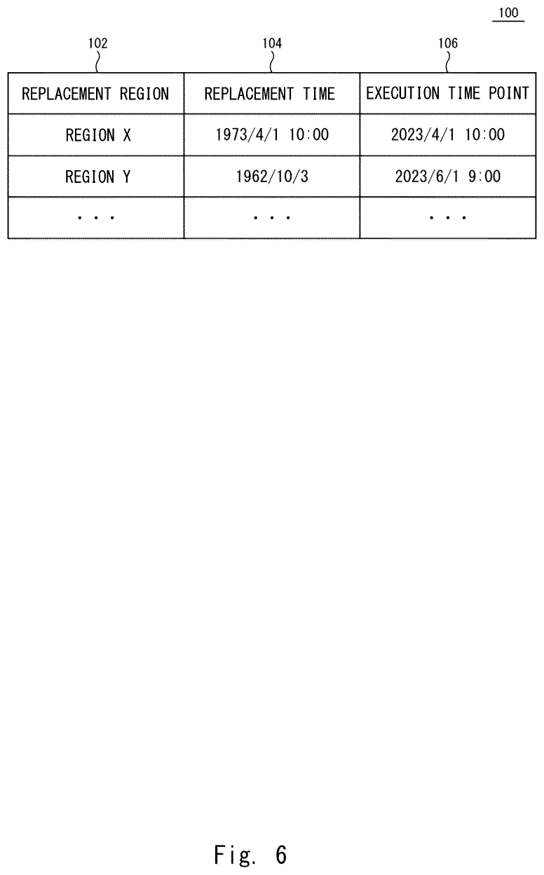

FIG. 6 is a diagram illustrating a configuration of the schedule information. In FIG. 6, schedule information 100 includes three attributes including a replacement region 102, a replacement time 104, and an execution time point 106. The execution time point 106 indicates a time point when replacement is executed.

For example, a record in a first row in FIG. 6 expresses that replacement “region X is replaced from one at the reference time with one at 10:00 am on Apr. 1, 1973” is executed at 10:00 am on Apr. 1, 2023. Therefore, when the current time becomes 10:00 am on Apr. 1, 2023, the determination unit 2040 determines “the region X” and “10:00 am on Apr. 1, 1973” respectively as the replacement region and the replacement time. Then, from three-dimensional data that expresses the target location 10 at 10:00 am on Apr. 1, 1973, three-dimensional data of the region X is acquired as the replacement three-dimensional data 50, and replacement is executed.

The method of executing the replacement at a specific date and time in this way is, for example, particularly useful in a case where it is desired to replace a part of the virtual space 20, in association with an event in the past or future. For example, a building or the like related to the event in the past can be automatically replaced with a building at the time of the event, at the same date and time as the event.

For example, it is assumed that a 50 years anniversary event of a department store D opened at 10:00 am on Apr. 1, 1973 be held in the virtual space 20. In this case, for example, replacement for a pair of “(replacement region, replacement time)=(region X around department store D, 10:00 am on April 1, 1973)” is scheduled at 10:00 am on Apr. 1, 2023. In this way, it is possible to automatically make a performance of “the surroundings of the department store D is replaced with a state at the time of opening, exactly 50 years after the opening of the department store D”, in the virtual space 20.

### Determination Based on Utterance of Avatar

The determination unit 2040 may determine the replacement time and the replacement region, based on content of the utterance of the avatar. In this case, for example, the determination unit 2040 detects a keyword related to a specific object in the target location 10, from the utterance, in response to the utterance of each avatar. The keyword is, for example, a name of a facility, a type of a facility, or the like.

In a case where the keyword is detected from the utterance of the avatar, the determination unit 2040 determines a region related to the keyword, as a replacement target region. The region related to the keyword is, for example, a region that expresses a facility represented by the keyword or the like.

Here, the region related to the keyword may be detected for the entire virtual space 20 or for a part of the virtual space 20. In the latter case, for example, the determination unit 2040 detects the region related the keyword, in a region having a predetermined size centered on the avatar that has uttered. In addition, for example, the determination unit 2040 detects the region related to the keyword, in a region having a predetermined size existing in a direction in which a line-of sight or a face of the avatar is directed.

The replacement time may be determined based on the facility specified from the utterance of the avatar or the like or may be determined based on an utterance regarding a time made by the avatar. In the former case, for example, based on a name of a facility detected from the utterance of the avatar, the determination unit 2040 specifies a time point when the facility having the name has existed. Then, the determination unit 2040 treats the specified time point as the replacement time.

In addition, although the facility exists at the reference time, a feature of the feature may differ from the facility in the past or future. For example, it is assumed that, although a color of a facility B is brown at the reference time, the color have been gray until 5 years ago. In such a case, it is assumed that the avatar has uttered that “the color of the facility B was gray in the past”.

In this case, the determination unit 2040 detects the name of the facility and the feature of the facility, from the utterance of the avatar. Then, the determination unit 2040 specifies a time point when the facility specified from the utterance of the avatar had the feature specified from the utterance of the avatar and determines the time point as the replacement time.

In a case where the replacement time is determined based on the utterance of the avatar related to the time, the determination unit 2040 detects a keyword related to the time, from the utterance of the avatar. Then, the determination unit 2040 determines the replacement time, by using the keyword.

For example, it is assumed that the avatar have uttered that “there was the facility B here until 5 years ago”. In this case, the determination unit 2040 detects “5 years ago” as the keyword related to the time. Then, the determination unit 2040 determines a time point 5 years before the current time, as the replacement time.

In a case where the avatars have a conversation, not at the time when the avatar utters alone, the determination unit 2040 may execute replacement based on the utterance of the avatar. In this case, for example, first, the determination unit 2040 detects an utterance of the avatar related to a specific object. Thereafter, the determination unit 2040 detects an utterance related to the utterance, from an utterance of another avatar. Then, in a case where the utterance related to the utterance is detected from the utterance of the another avatar, the determination unit 2040 determines the replacement region and the replacement time, based on the utterance of the another avatar.

Here, whether the two utterances are related to each other can be determined, for example, by determining whether a relevance degree of these two utterances is equal to or more than a threshold. The relevance degree of the two utterances can be calculated, for example, by using a machine learning model (hereinafter, a relevance degree calculation model).

The relevance degree calculation model is configured to output a relevance degree of the two utterances in response to input of the two utterances. The relevance degree calculation model is learned in advance by using a plurality of pieces of training data. Each piece of the training data includes, for example, a pair of input data indicating a combination of two utterances and a relevance degree of theses utterances (that is, correct answer (ground-truth) output data).

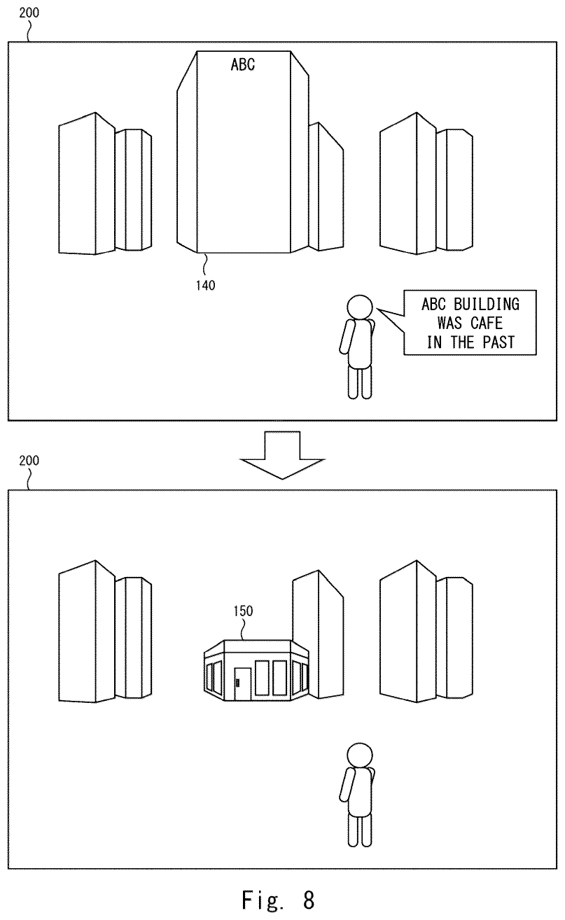

FIG. 8 is a first diagram illustrating a case where the replacement region and the replacement time are determined by the utterance of the avatar. In this example, the avatar has uttered that “An ABC building was a cafe in the past”. The determination unit 2040 replaces the ABC building with a cafe (a building 150) existed in the past before the reference time, at a place where the ABC building (a building 140) currently exists, based on this utterance.

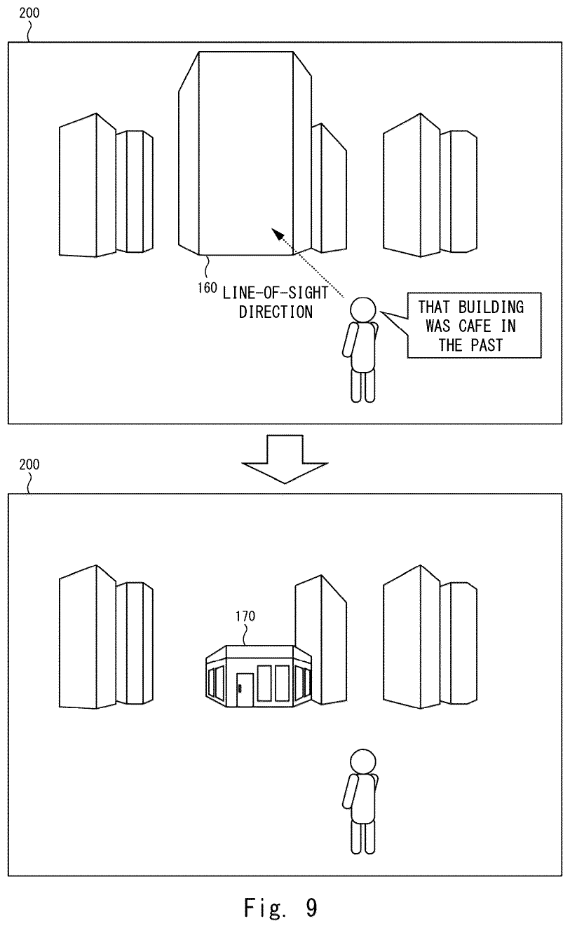

FIG. 9 is a second diagram illustrating a case where the replacement region and the replacement time are determined by the utterance of the avatar. In this example, the avatar has uttered that “that building was a cafe in the past”. Unlike the example in FIG. 8, in the example in FIG. 9, the utterance of the avatar does not include a specific name of the building to be replaced.

On the other hand, the utterance of the avatar includes a word “building” that expresses a type of a building and a demonstrative “that”. Because the demonstrative “that” is used, the replacement region can be predicted to exist in a line-of-sight direction of the avatar. Therefore, the determination unit 2040 specifies a region representing the building, in a region existing in the line-of-sight direction of the avatar, as the replacement region. As a result, a building 160 is specified as the replacement region. Then, at a place where the building 160 currently exists, the building 160 is replaced with a cafe (a building 170) that has existed in the past before the reference time. Instead of the line-of-sight direction, a direction of a face may be used.

### Determination Based on Attribute of Avatar

The determination unit 2040 may determine the replacement region and the replacement time, based on the attribute of the avatar. The attribute of the avatar used to determine the replacement region and the replacement time is, for example, an age of the avatar.

For example, in a case where a predetermined number or more avatars of the same age group gather in a region having a predetermined size, in the virtual space 20, the determination unit 2040 determines the replacement region and the replacement time, based on the age group of these avatars (hereinafter, an avatar group). The age group is, for example, each numerical range, obtained by dividing a numerical range of the age into a plurality of ranges. Such a numerical range includes, for example, 30s (that is, equal to or older than 30 years old and younger than 40 years old) or the like.

For example, the determination unit 2040 determines the replacement time, based on the age group of the avatar group and a reference age group. The reference age group expresses an age of the user in a scene that the user desired to see.

For example, it is assumed that it is desired for the user to recall memories of one's younger days by showing the user a scene when the user was in one's 10s. It is assumed that the age group of the avatar group be 40s. In this case, a scene when the user is in one's 10s can be provided, by providing a scene of about 30 (=40-10) years ago to the user. Therefore, the determination unit 2040 determines a time point 30 years ago from the current time point, as the replacement time, based on the age group of the avatar group that is 40s and the reference age group that is 10s.

The replacement region is, for example, a region around the avatar group. For example, the determination unit 2040 determines a region having a predetermined size centered on the avatar group, as a reference region. In addition, for example, the determination unit 2040 may determine a region having a predetermined size existing in the line-of-sight direction of the avatar group or the direction of the face, as the reference region. The line-of-sight direction of the avatar group is calculated, for example, as a statistical value (for example, an average) of the line-of-sight directions of the plurality of avatars included in the avatar group. The same applies to the direction of the face.

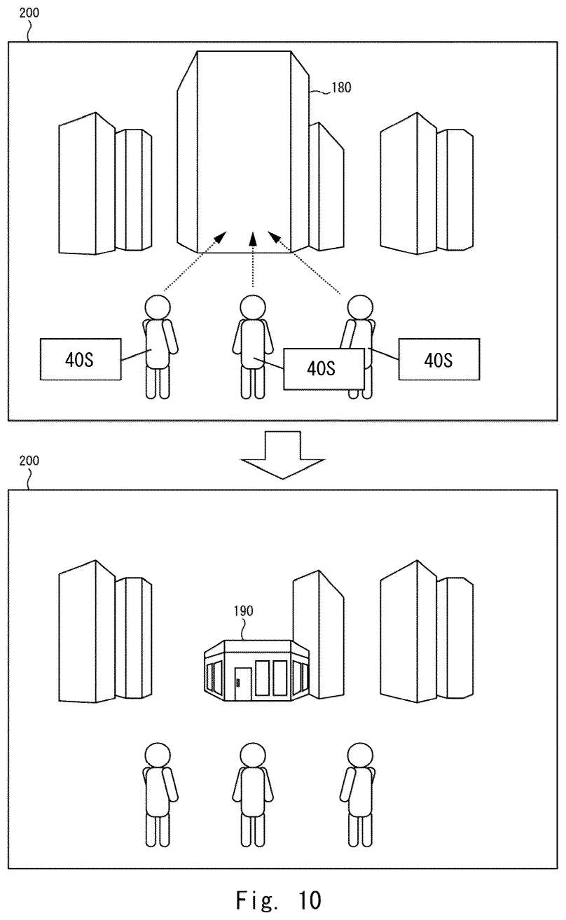

FIG. 10 is a diagram illustrating a case where the replacement time and the replacement region are determined based on the attribute of the avatar. In the example in FIG. 10, if three or more avatars in the same age group gather, a building or the like existing in the line-of-sight direction of the avatar group is replaced with a building or the like that has existed when the avatar group are in their 10s.

In this regard, in the example in FIG. 10, three avatars belonging to the same age group that is 40s gather. Therefore, a building 180 existing in a line-of-sight direction of these avatar group is specified as the replacement region. At a time point when the avatar group is in their 10s, that is, 30 years ago is specified as the replacement time. Therefore, the building 180 is replaced with a building 190 that has existed 30 years ago at the place of the building 180.

### Acquisition of Replacement Three-Dimensional Data 50: S106

The second acquisition unit 2060 acquires the replacement three-dimensional data 50 that expresses the replacement region at the replacement time (S106). For example, the second acquisition unit 2060 determines three-dimensional data closest to the replacement time, from three-dimensional data that expresses the target location 10, prepared for each of a plurality of time points. Then, the determination unit 2040 acquires three-dimensional data of a part related to the replacement region, as the replacement three-dimensional data 50, from the determined three-dimensional data.

### Generation of Virtual Space Data 30: S108

The generation unit 2080 generates the virtual space data 30, by combining the reference three-dimensional data 40 with the replacement three-dimensional data 50 (S108). Specifically, the generation unit 2080 generates the virtual space data 30, by replacing a part related to the replacement region, in the reference three-dimensional data 40, with the replacement three-dimensional data 50.

When a part of the reference three-dimensional data 40 is replaced with the replacement three-dimensional data 50, the generation unit 2080 may execute interpolation processing or the like, so as to smoothly connect the reference three-dimensional data 40 to the replacement three-dimensional data 50. Here, for a specific technique for executing the interpolation processing or the like to smoothly connect two pieces of three-dimensional data, an existing technique can be used.

Here, in a case where replacement using the replacement three-dimensional data 50 is repeatedly performed, the virtual space data 30 may have already been generated. In this case, the generation of the virtual space data 30 includes updating the virtual space data 30 that has already been generated.

Specifically, the generation unit 2080 updates the virtual space data 30, by replacing a part of the virtual space data 30 (a part of the reference three-dimensional data 40 included in the virtual space data 30) with the replacement three-dimensional data 50.

### Output of Result

The virtual space-providing apparatus 2000 outputs information, using the generated virtual space data 30. The information output by the virtual space-providing apparatus 2000 is video data of the virtual space 20, for example, generated by using the virtual space data 30.

For example, the virtual space-providing apparatus 2000 repeatedly generates, for each avatar, image data of the virtual space 20 within an imaging range of a virtual camera related to the avatar, by using the virtual space data 30. As a result, the video data to be provided to a user of the avatar is generated, for each avatar. The virtual space-providing apparatus 2000 transmits the video data generated for each avatar, to a user terminal of the user related to the avatar. In this way, because a video expressing a state of the virtual space 20 is provided to the user, the user can use the virtual space 20, by using the avatar.

The processing for generating the video data by using the virtual space data 30 may be executed by the user terminal. In this case, the virtual space-providing apparatus 2000 provides the virtual space data 30 to the user terminal. The user terminal generates the video data described above, by using the virtual space data 30 provided from the virtual space-providing apparatus 2000.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

In the above-described example, the program includes a group of instructions (or a software code) for causing a computer to perform one or more functions described in the example embodiments when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk, or other optical disk storages, a magnetic cassette, a magnetic tape, a magnetic disk storage, or other magnetic storage devices. The program may be transmitted on a transitory computer-readable medium or a communications medium. As an example and not by way of limitation, a transitory computer-readable or communication medium includes electrical, optical, acoustic, or other forms of propagated signals.

Some or all of the above-described example embodiments may be described as the following supplementary notes, but are not limited to the following supplementary notes.

### Supplementary Note 1

A virtual space-providing apparatus including:
first acquisition means for acquiring reference three-dimensional data that is three-dimensional data that expresses a target location at a reference time;
determination means for determining a replacement time that is a time point different from the reference time and a replacement region that is a region, in the target location, where an object included therein is to be replaced from an object at the reference time with an object at the replacement time;
second acquisition means for acquiring replacement three-dimensional data that is three-dimensional data that expresses the replacement region at the replacement time; and
generation means for generating virtual space data that is three-dimensional data that expresses a virtual space, by combining the reference three-dimensional data and the replacement three-dimensional data.

### Supplementary Note 2

The virtual space-providing apparatus according to supplementary note 1, in which the determination means acquires the replacement region and the replacement time associated with an execution time point that matches a current time, from schedule information that associates the execution time point of replacement with a pair of the replacement region and the replacement time.

### Supplementary Note 3

The virtual space-providing apparatus according to supplementary note 1, in which the determination means determines the replacement region or the replacement time, based on an utterance or an attribute of an avatar used in the virtual space.

### Supplementary Note 4

The virtual space-providing apparatus according to supplementary note 3, in which the determination means detects a region to be treated as the replacement region, from a region within a predetermined range including the avatar or a region within a predetermined range existing in a direction in which a line-of-sight or a face of the avatar is directed.

### Supplementary Note 5

The virtual space-providing apparatus according to supplementary note 3 or 4, in which
the determination means
detects a first keyword that expresses a name or a type of an object, from the utterance of the avatar, and
determines a region where the object having the name or the type specified by the first keyword has existed, in the target location at the replacement time, as the replacement region.

### Supplementary Note 6

The virtual space-providing apparatus according to supplementary note 5, in which the determination means determines a time point when the object having the name or the type specified by the first keyword has existed in the target location, as the replacement time.

### Supplementary Note 7

The virtual space-providing apparatus according to supplementary note 5, in which
the determination means
detects a second keyword that expresses a time point, from the utterance of the avatar, and
determines a time point specified by the second keyword, as the replacement time.

### Supplementary Note 8

The virtual space-providing apparatus according to supplementary note 3 or 4, in which, in a case where a predetermined number or more of avatars belonging to a same age group exist within a predetermined range, in the virtual space, the determination means determines a time point when these avatars belong to a reference age group, as the replacement time.

### Supplementary Note 9

A virtual space-providing method executed by a computer including:
a first acquisition step for acquiring reference three-dimensional data that is three-dimensional data that expresses a target location at a reference time;
a determination step for determining a replacement time that is a time point different from the reference time and a replacement region that is a region, in the target location, where an object included therein is to be replaced from an object at the reference time with an object at the replacement time;
a second acquisition step for acquiring replacement three-dimensional data that is three-dimensional data that expresses the replacement region at the replacement time; and
a generation step for generating virtual space data that is three-dimensional data that expresses a virtual space, by combining the reference three-dimensional data and the replacement three-dimensional data.

### Supplementary Note 10

The virtual space-providing method according to supplementary note 9, further including, in the determination step, acquiring the replacement region and the replacement time associated with an execution time point that matches a current time, from schedule information that associates the execution time point of replacement with a pair of the replacement region and the replacement time.

### Supplementary Note 11

The virtual space-providing method according to supplementary note 9, further including, in the determination step, determining the replacement region or the replacement time, based on an utterance or an attribute of an avatar used in the virtual space.

### Supplementary Note 12

The virtual space-providing method according to supplementary note 11, further including, in the determination step, detecting a region to be treated as the replacement region, from a region within a predetermined range including the avatar or a region within a predetermined range existing in a direction in which a line-of-sight or a face of the avatar is directed.

### Supplementary Note 13

The virtual space-providing method according to supplementary note 11 or 12, further including:
in the determination step,
detecting a first keyword that expresses a name or a type of an object, from the utterance of the avatar; and
determining a region where the object having the name or the type specified by the first keyword has existed, in the target location at the replacement time, as the replacement region.

### Supplementary Note 14

The virtual space-providing method according to supplementary note 13, further including, in the determination step, determining a time point when the object having the name or the type specified by the first keyword has existed in the target location, as the replacement time.

### Supplementary Note 15

The virtual space-providing method according to supplementary note 13, further including:
in the determination step,
detecting a second keyword that expresses a time point, from the utterance of the avatar; and
determining a time point specified by the second keyword, as the replacement time.

### Supplementary Note 16

The virtual space-providing method according to supplementary note 11 or 12, further including, in the determination step, in a case where a predetermined number or more of avatars belonging to a same age group exist within a predetermined range, in the virtual space, determining a time point when these avatars belong to a reference age group, as the replacement time.

### Supplementary Note 17

A non-transitory computer-readable medium storing a program for causing a computer to execute processing including:
a first acquisition step for acquiring reference three-dimensional data that is three-dimensional data that expresses a target location at a reference time;
a determination step for determining a replacement time that is a time point different from the reference time and a replacement region that is a region, in the target location, where an object included therein is to be replaced from an object at the reference time with an object at the replacement time;
a second acquisition step for acquiring replacement three-dimensional data that is three-dimensional data that expresses the replacement region at the
a generation step for generating virtual space data that is three-dimensional data that expresses a virtual space, by combining the reference three-dimensional data and the replacement three-dimensional data.

### Supplementary Note 18

The medium according to supplementary note 17, further including, in the determination step, acquiring the replacement region and the replacement time associated with an execution time point that matches a current time, from schedule information that associates the execution time point of replacement with a pair of the replacement region and the replacement time.

### Supplementary Note 19

The medium according to supplementary note 17, further including, in the determination step, determining the replacement region or the replacement time, based on an utterance or an attribute of an avatar used in the virtual space.

### Supplementary Note 20

The medium according to supplementary note 19, further including, in the determination step, detecting a region to be treated as the replacement region, from a region within a predetermined range including the avatar or a region within a predetermined range existing in a direction in which a line-of-sight or a face of the avatar is directed.

### Supplementary Note 21

The medium according to supplementary note 19 or 20, further including:
in the determination step,
detecting a first keyword that expresses a name or a type of an object, from the utterance of the avatar; and
determining a region where the object having the name or the type specified by the first keyword has existed, in the target location at the replacement time, as the replacement region.

### Supplementary Note 22

The medium according to supplementary note 21, further including, in the determination step, determining a time point when the object having the name or the type specified by the first keyword has existed in the target location, as the replacement time.

### Supplementary Note 23

The medium according to supplementary note 21, further including:
in the determination step,
detecting a second keyword that expresses a time point, from the utterance of the avatar; and
determining a time point specified by the second keyword, as the replacement time.

### Supplementary Note 24

The medium according to supplementary note 19 or 20, further including, in the determination step, in a case where a predetermined number or more of avatars belonging to a same age group exist within a predetermined range, in the virtual space, determining a time point when these avatars belong to a reference age group, as the replacement time.

### REFERENCE SIGNS LIST

10 target location
20 virtual space
30 virtual space data
40 reference three-dimensional data
50 replacement three-dimensional data
60 user
70 user terminal
80 avatar
90 avatar data
100 schedule information
102 replacement region
104 replacement time
106 execution time point
110 building
120 input interface
130 building
140 building
150 building
160 building
170 building
190 building
200 display screen
1000 computer
1020 bus
1040 processor
1060 memory
1080 storage device
1100 input/output interface
1120 network interface
2000 virtual space-providing apparatus
2020 first acquisition unit
2040 determination unit
2060 second acquisition unit
2080 generation unit

What is claimed is:

1. A virtual space-providing apparatus comprising:
at least one memory that is configured to instructions; and
at least one processor that is configured to execute the instructions to:
acquire reference three-dimensional data that is three-dimensional data that expresses a target location at a reference time;
determine a replacement time and a replacement region, the replacement time being a time point different from the reference time, the replacement region being a region, in the target location, where an object included therein is to be replaced from an object at the reference time with an object at the replacement time;
acquire replacement three-dimensional data that is three-dimensional data that expresses the replacement region at the replacement time; and
generate virtual space data that is three-dimensional data that expresses a virtual space, by combining the reference three-dimensional data and the replacement three-dimensional data.

2. The virtual space-providing apparatus according to claim 1, wherein the determination of the replacement time and the replacement region includes acquiring the replacement region and the replacement time associated with an execution time point that matches a current time, from schedule information that associates the execution time point of replacement with a pair of the replacement region and the replacement time.

3. The virtual space-providing apparatus according to claim 1, wherein the determination of the replacement time and the replacement region includes determining the replacement region or the replacement time based on an utterance or an attribute of an avatar used in the virtual space.

4. The virtual space-providing apparatus according to claim 3, wherein the determination of the replacement region includes detecting a region to be treated as the replacement region, from a region within a predetermined range including the avatar or a region within a predetermined range existing in a direction in which a line-of-sight or a face of the avatar is directed.

5. The virtual space-providing apparatus according to claim 3,
wherein the determination of the replacement region includes:
detecting a first keyword that expresses a name or a type of an object, from the utterance of the avatar; and
determining a region where the object having the name or the type specified by the first keyword has existed, in the target location at the replacement time, as the replacement region.

6. The virtual space-providing apparatus according to claim 5, wherein the determination of the replacement time includes determining a time point when the object having the name or the type specified by the first keyword has existed in the target location, as the replacement time.

7. The virtual space-providing apparatus according to claim 5,
wherein the determination of the replacement time includes:
detecting a second keyword that expresses a time point, from the utterance of the avatar; and
determining time point specified by the second keyword, as the replacement time.

8. The virtual space-providing apparatus according to claim 3, wherein, in a case where a predetermined number or more of avatars belonging to a same age group exist within a predetermined range, in the virtual space, the determination means determines a time point when these avatars belong to a reference age group, as the replacement time.

9. A virtual space-providing method executed by a computer comprising:
acquiring reference three-dimensional data that is three-dimensional data that expresses a target location at a reference time;
determining a replacement time and a replacement region, the replacement time being a time point different from the reference time, the replacement region being a region, in the target location, where an object included therein is to be replaced from an object at the reference time with an object at the replacement time;
acquiring replacement three-dimensional data that is three-dimensional data that expresses the replacement region at the replacement time; and
generating virtual space data that is three-dimensional data that expresses a virtual space, by combining the reference three-dimensional data and the replacement three-dimensional data.

10. The virtual space-providing method according to claim 9, wherein the determination of the replacement time and the replacement region includes acquiring the replacement region and the replacement time associated with an execution time point that matches a current time, from schedule information that associates the execution time point of replacement with a pair of the replacement region and the replacement time.

11. The virtual space-providing method according to claim 9, wherein the determination of the replacement time and the replacement region includes determining the replacement region or the replacement time, based on an utterance or an attribute of an avatar used in the virtual space.

12. The virtual space-providing method according to claim 11, wherein the determination of the replacement region includes detecting a region to be treated as the replacement region, from a region within a predetermined range including the avatar or a region within a predetermined range existing in a direction in which a line-of-sight or a face of the avatar is directed.

13. The virtual space-providing method according to claim 11,
wherein the determination of the replacement region includes:
detecting a first keyword that expresses a name or a type of an object, from the utterance of the avatar; and
determining a region where the object having the name or the type specified by the first keyword has existed, in the target location at the replacement time, as the replacement region.

14. The virtual space-providing method according to claim 13, wherein the determination of the replacement time includes determining a time point when the object having the name or the type specified by the first keyword has existed in the target location, as the replacement time.

15-16. (canceled)

17. A non-transitory computer-readable medium storing a program for causing a computer to execute:
acquiring reference three-dimensional data that is three-dimensional data that expresses a target location at a reference time;
determining a replacement time and a replacement region, the replacement time being a time point different from the reference time, the replacement region being a region, in the target location, where an object included therein is to be replaced from an object at the reference time with an object at the replacement time;
acquiring replacement three-dimensional data that is three-dimensional data that expresses the replacement region at the replacement time; and
generating virtual space data that is three-dimensional data that expresses a virtual space, by combining the reference three-dimensional data and the replacement three-dimensional data.

18. The medium according to claim 17, wherein the determination of the replacement time and the replacement region includes acquiring the replacement region and the replacement time associated with an execution time point that matches a current time, from schedule information that associates the execution time point of replacement with a pair of the replacement region and the replacement time.

19. The medium according to claim 17, wherein the determination of the replacement time and the replacement region includes determining the replacement region or the replacement time, based on an utterance or an attribute of an avatar used in the virtual space.

20. The medium according to claim 19, wherein the determination of the replacement region includes detecting a region to be treated as the replacement region, from a region within a predetermined range including the avatar or a region within a predetermined range existing in a direction in which a line-of-sight or a face of the avatar is directed.

21. The medium according to claim 19,
wherein the determination of the replacement region includes
detecting a first keyword that expresses a name or a type of an object, from the utterance of the avatar; and
determining a region where the object having the name or the type specified by the first keyword has existed, in the target location at the replacement time, as the replacement region.

22. The medium according to claim 21, wherein determination of the replacement time includes determining a time point when the object having the name or the type specified by the first keyword has existed in the target location, as the replacement time.

23-24. (canceled)
